(19) United States
(12) Patent Application Publication
(10) Pub. No.: US 2026/0342741 A1
(43) Pub. Date: Oct. 29, 2026

(54) BENES NETWORK CONNECTED PROCESSING ENTITY ARRAY ROUTING

(71) Applicant: Mobileye Vision Technologies Ltd., Jerusalem (IL)

(72) Inventor: Koby Yacob TAYREE, Midrakh Oz (IL)

(21) Appl. No.: 19/120,615

(22) PCT Filed: Oct. 13, 2023
(86) PCT No.: PCT/IB2023/000593

§ 371 Date: Apr. 11, 2025

Related U.S. Application Data
(60) Provisional application No. 63/415,946, filed on Oct. 13, 2022.

(51) Int. Cl. H04L 49/1515; H04L 49/111; H04L 49/25

(52) U.S. Cl. CPC H04L 49/1515; H04L 49/111; H04L 49/25

(57) ABSTRACT

A method for finding a Benes network (BN) compliant transformation, the method may include receiving, by a transformation evaluation circuit, evaluated transformation (ET) information that represents a ET between multiple BN input ports to multiple output subsets of BN output ports; wherein the BN is a transformation supporting BN; determining an output bounding interval that bounds a numerical range defined by an output subset of the multiple output subsets; determining, by the transformation evaluation circuit, whether the ET is BN compliant based on, at least, the output bounding interval and the multiple output subsets; and responding, by the transformation evaluation circuit, to the determining.

### PRIORITY

This application claims the benefit of priority to U.S. Provisional Patent Application Ser. No. 63/415,946, filed Oct. 13, 2022, which is incorporated by reference herein in its entirety.

### BACKGROUND

The need to increase the throughput and performance of computerized system has driven the industry to use arrays of processing entities. An array of processing entities may be designed to fulfill a computation graph. The array may be in communication with a Benes network. A placement and routing process for determining the locations of the processing entities of the array, the connectivity between the processing entities and the connectivity to the Benes network is time consuming and takes many hours to complete. There is a growing need to provide an efficient, cost effective and scalable solution for placement and routing of processing entities of an array of processing entities that communicates with a Benes network.

### SUMMARY

There may be provided a method, non-transitory computer readable medium for placement and routing of processing entities of an array of processing entities.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates an example of a system;

FIG. 2 illustrates an example of an image processor;

FIG. 3 illustrates an example of an array of processing entities and various connections;

FIG. 4 illustrates an example of a processing entity; and

FIG. 5 illustrates an example of a method.

### DETAILED DESCRIPTION

In the following detailed description, numerous specific details are set forth in order to provide a thorough understanding of the embodiments of the disclosure. However, it will be understood by those skilled in the art that the present embodiments of the disclosure may be practiced without these specific details. In other instances, well-known methods, procedures, and components have not been described in detail so as not to obscure the present embodiments of the disclosure.

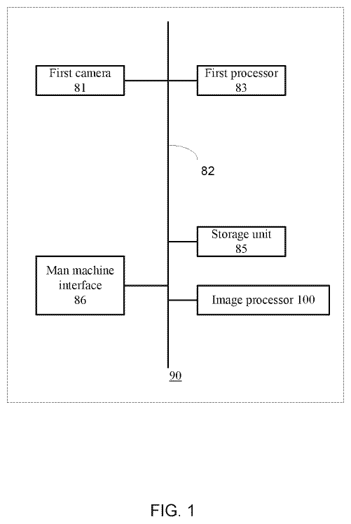

FIG. 1 illustrates a system 90 according to an embodiment of the invention.

System 90 may be a Driver Assistance System, a part of an autonomous car control module, and the like.

The system 90 may be installed in a vehicle, such as a car (not shown). At least some of the components of the system 90 are within the vehicle.

System 90 may include first camera 81, first processor 83, storage unit 85, human-machine interface 86, and an image processor 100. These components may be coupled to each other via bus or network 82 or by any other arrangement.

The system 90 may include additional cameras and/or additional processors and/or additional image processors.

First processor 83 may determine which task should be executed by the image processor 100 and instruct the image processor 100 to operate accordingly.

It is noted that image processor 100 may be a part of the first processor 83 and that it may be a part of any other system.

The human-machine interface 86 may include a display, a speaker, one or more light emitting diodes, a microphone or any other type of man machine interface. The human machine interface may communicate with a mobile device of the driver of the car, with the multimedia systems of the car, and the like.

The system 90 may be not related to driving and may perform tasks not related to driving—for example, any task that may require parallel processing. The system may include sensors other that the first camera—and may not include the first camera.

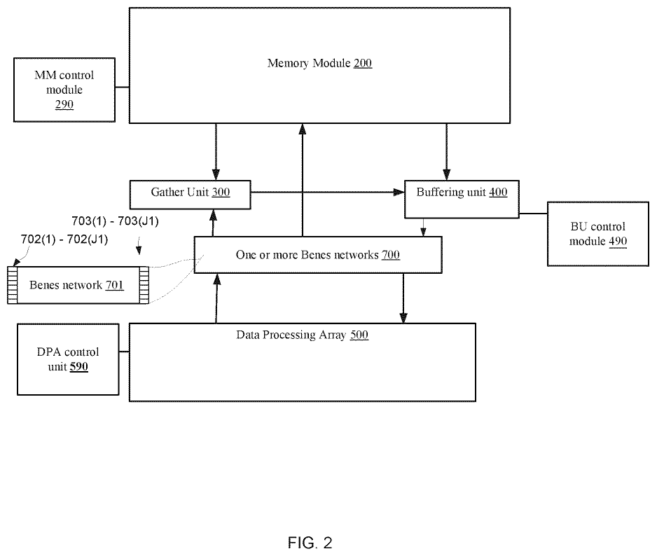

FIG. 2 illustrates image processor 100 according to an embodiment of the invention.

Image processor 100 may include Memory module 200, MM control unit 290, Gather unit (GU) 300, Buffering unit (BU) 400, BU control module 490, Data processing array (DPA) 500, DPA control unit 590, one or more Benes networks 700, and other components that are not shown for brevity of explanation. FIG. 2 illustrates a Benes network 701 of the one or more Benes networks—as including a plurality (J1) of input ports 702(1)-702(J1) and a plurality (J1) of output ports 703(1)-703(J1).

Memory module 200 is in communication with gather unit 300, in communication with buffering unit 400 and in communication, via the one or more Benes networks 700, with DPA 500.

Gather unit 300 is in communication with memory module 200, in communication with buffering unit 400 and in communication, via the one or more Benes networks 700, with DPA 500.

Buffering unit 400 is in communication with gather unit 300, in communication with memory module 200 and in communication, via the one or more Benes networks 700, with DPA 500.

Memory module 200 is the highest-level memory resource of image processor 100. Buffering unit 400 and gather unit 300 are lower-level memory resources of the image processor 100 and may be configured to fetch data from the memory module 200 and provide the data via the one or more Benes networks 700 to the DPA 500. DPA 500 may send data to memory module 200, via the one or more Benes networks 700.

DPA 500 includes multiple data processors (also referred to as processing entities PEs) and are arranged to perform computational tasks such as but not limited to image processing algorithms. Non-limiting examples of image processing algorithms include a warp algorithm, disparity, and the like.

Gather unit 300 includes a cache memory. Gather unit 300 is configured to receive from DPA 500 requests to fetch multiple data units (such as pixels) and to fetch the requested pixels—from the cache memory or from memory unit. The Gather unit 300 may operate in a pipelined manner and have a limited number (for example three) of pipeline stages of a very low latency—for example one (or less than five or ten) clock cycles. As indicated below—the gather unit may also fetch data units in additional modes—while using an address generator of the memory module to fetch information.

Buffering unit 400 is configured to act as a buffer of data between the memory module 200 and the DPA 500. The buffering unit 400 may be arranged to provide data in parallel to multiple data processors of the DPA 500.

DPA 500 exhibits an architecture that may support parallel and pipeline implementation. It exhibits a flexible connectivity, enables to connect almost every data processing unit (DPU) to every DPU.

For example, a PE may include Q1 local input ports and Q1 output ports for locally communicating with Q1 neighbors, may include a plurality of remote communication (RC) I/O ports for remote communication (for example with one or more Benes networks). The RC I/O ports may include Q2 RC input ports and Q3 RC input port (for example 1 unicast BN output port and 2 unicast BN input ports—although other numbers may be provided). The PE may include Q4 input ports for receiving broadcast (concurrently provided to a group of PEs—such as a line of PEs or a column of PEs or any 2D group of PEs of the array).

An array such as a coarse-grained Reconfigurable Array (CGRA) of processing elements (PEs) (also referred to as processing entities) can abstractly be viewed as a lattice of Processing Elements (PEs), where each PE have a limited connectivity to its neighbors, a feature referred to as locality constraints.

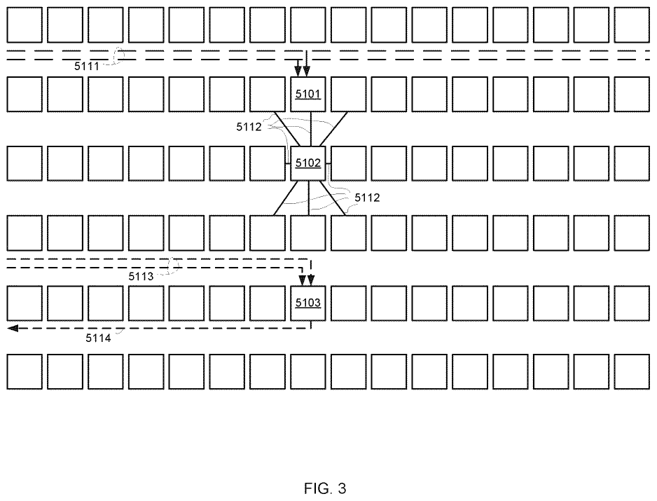

For each PE, there are two kinds of locality constrained neighbors—a set of local data producers—those neighbors PEs which can transmit data to it, and a set of local consumers, defined similarly. See, for example, in FIG. 3—an array of PEs may include multiple PEs—such as PE 5102 in FIG. 3 that has eight neighbors—that may include producers, consumers, and PEs that are both consumers and producers.

A CGRA realization may allow additional set of shallow connectivity to non-neighbor PEs, which tend to be scarce and insufficient to manifest non-trivial computations.

A computation graph represents inputs programs, where different nodes represent operations and (directed) edges represent producer-to-consumer relations.

FIG. 3 illustrates an array of PEs and illustrates local input and output ports 5112 (one line per neighbor PE) of PE 5102, two input ports 5111 of PE 5101 for receiving broadcasts, one output RC port 5114 of PE 5103 and two input RC ports 5113 of PE 5103. A single PE may have all three types of ports—but for brevity of explanation different types of ports are shown in relation to different PEs.

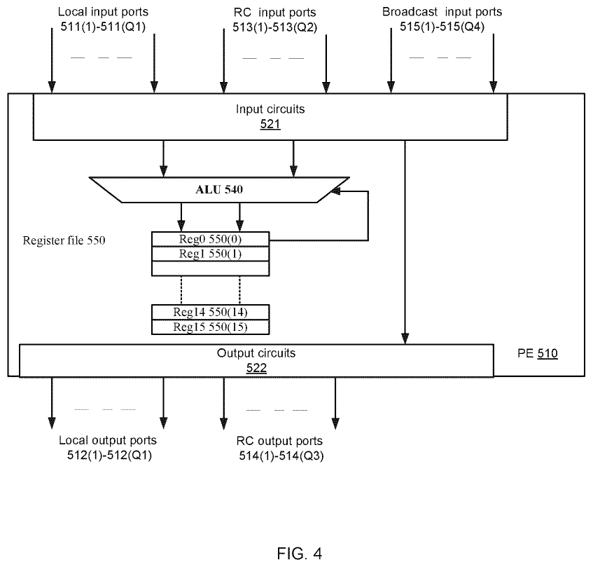

FIG. 4 illustrates an example of PE 510 that may include Q1 local input ports 511(1)-511(Q1) and Q1 output ports 512(1)-512(Q1) for locally communicating with Q1 neighbors may include I/O ports for remote communication (RC) (for example with one or more Benes networks). The I/O ports for RC may include Q2 input ports 513(1)-513(Q2) and Q3 output ports 514(1)-514(Q3) (for example 1 unicast BN output port and 2 unicast BN input ports—although other numbers may be provided). The PE may include Q4 input ports 515(1)-515(Q4) for receiving broadcast (concurrently provided to a group of PEs-such as a line of PEs or a column of PEs or any 2D group of PEs of the array). PE 510 may also include input circuits 521 (for example multiple multiplexers and control signals) for receiving content from the input ports and conveying the content to a computation core that may include an arithmetic logic unit (ALU) 540, and registers 550(0)-550(15) of a register file 550. The content of the computation core and/or content from the input circuits may be fed to output circuits 522 (for example multiple multiplexers and control signals) that output the content from any of the output ports of PE 510. The number of input neighbors and output neighbors may differ from each other.

An array of processing entities (PEs) may be in communication with each other through a Benes network. It should be noted that other hardware units such as memories, may also be in communication via the Benes network (BN). It is assumed that the BN supports transformations.

The functionality of the array may require implementing a transformation between multiple BN input ports to multiple output subsets of BN output ports. An output subset may include one or more BN output ports. An output subset may include more than a single BN output port when a single BN input port is mapped (via the transformation) to two or more BN output ports. For example, the transformation T={0→{0,3,8}, 1→{1,2,7}, 2→{5, 10,18}, 3→{4,11,12,13}} maps four BN input ports 0, 1, 2 and 3 to four corresponding output subsets {0,3,8}, {1,2,7}, {5,10,18} and {4, 11, 12, 13}, respectively.

When the BN has to implement a certain transformation, there is a need to determine whether the certain transformation may be implemented by the BN—whether the BN is a BN compliant transformation.

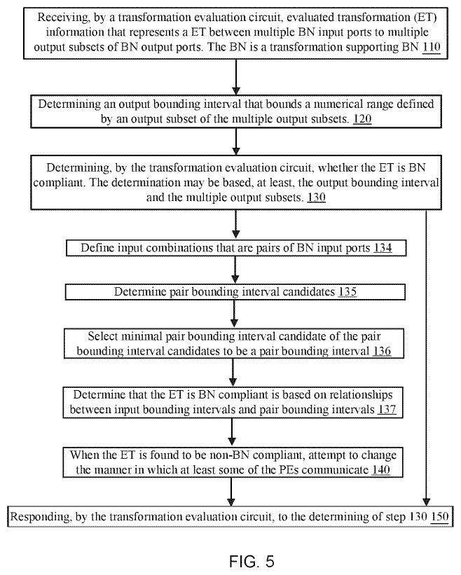

FIG. 5 illustrates a method for finding a BN compliant transformation.

FIG. 5 may start by step 110 of receiving, by a transformation evaluation circuit, evaluated transformation (ET) information that represents a ET between multiple BN input ports to multiple output subsets of BN output ports. The BN is a transformation supporting BN.

The transformation evaluation circuit may include one or more processing circuits and may be configured to execute the method shown in FIG. 5.

Step 110 may be followed by step 120 of determining an output bounding interval that bounds a numerical range defined by an output subset of the multiple output subsets.

Step 120 may be followed by step 130 of determining, by the transformation evaluation circuit, whether the ET is BN compliant. The determination may be based, at least, the output bounding interval and the multiple output subsets.

The determination of step 130 may be responsive to multiple output bounding intervals.

The determination of step 130 may be responsive to one or more input bounding intervals. An input bounding interval bounds a numerical range defined by an input combination of BN input ports.

An output bounding interval may be start at a value that equals n*2k and has a length of 2k. Values k and n are non-negative integers. The same applies, mutatis mutandis to an input bounding interval.

For example:

$${I}_{n}^{{2}^{k}} {=}^{△} [ n \cdot {2}^{k} … ( ( n + 1 ) \cdot {2}^{k} ) - 1 ]$$

$${I}_{0}^{4} = [ 0 , 1 , 2 , 3 ]$$

$${I}_{1}^{128} = [ 128 … 255 ]$$

$${I}_{3}^{32} = [ 96 … 127 ]$$

The output bounding interval may be the minimal (smallest) output bounding interval that bounds the numerical range. The same applies, mutatis mutandis to an input bounding interval.

For example, assuming that the mapping is T={0→[0,2], 1→[4], 2→[1], 4→[3], 6→[8], 7→[6]}. A first output subset of [0,2] is related to a numerical range of 0-2. The minimal output bounding interval related to 0-2 start at a value that equals n*2k and has a length of 2k is [0,1,2,3], of length 4, wherein n=zero and k=2.

Step 130 may include determining that the ET is BN compliant when there are between one and two output subsets of the multiple output subsets that are bound by the output bounding interval.

In this example, output subset [0,2] defines the interval [0,1,2,3]

In which, we have three participants—
0→[0,2]
2→[1]
4→[3]
   Hence—the method shown in FIG. 5 cannot determine whether the mapping is BN compliant.

Step 130 may include determining whether the ET is BN compliant by steps 131, 132 and 133.

Step 131 may include finding one or more output bounding interval owner. An owner may be determined as follows:

$$owner ( i \to \{ {j}_{0} … {j}_{r} \} , {I}_{n}^{{2}^{k}} ) {=}^{△} \{ \begin{matrix}\begin{matrix}\begin{matrix}\{ {j}_{0} … {j}_{r} \} ⊆ k is minimal , \\ \overline{1} 0 < r , {k}_{i} \neq {j}_{k} ,\end{matrix} \\ \begin{matrix}there ' s no containing \\ interval owned\end{matrix}\end{matrix} \\ false\end{matrix}$$

Step 131 may be followed by step 132 of finding one or more output bounding interval participants. A participant may be an owner or not. A participant may be determined as follows:

$$participant ( i \to \{ {j}_{0} … {j}_{r} \} , {I}_{n}^{{2}^{k}} ) {=}^{△} \{ \begin{matrix}{I}_{n}^{{2}^{k}} is owned , \{ {j}_{0} … {j}_{r} \} ⊆ {I}_{n}^{{2}^{k}} \\ false\end{matrix}$$

Step 132 may be followed by step 133 of determining whether an output bounding interval of the ET has an owner and a predefined number of participants. For example—checking if there are one or two participants.

For example, assuming the mapping:

$$T = 0 \to \{ 47 , 50 \} , 1 \to \{ 1 , 10 \} , 2 \to \{ 32 \} , 23 \to \{ 32 , 48 \} , 33 \to \{ 48 , 63 \} :$$

$$owner ( 0 \to \{ 47 , 50 \} , {I}_{1}^{32} ) = true$$

$$participant ( 1 \to \{ 1 , 10 \} , {I}_{1}^{32} ) = false$$

$$participant ( 2 \to \{ 32 \} , {I}_{1}^{32} ) = true$$

$$participant ( 23 \to \{ 32 , 48 \} , {I}_{1}^{32} ) = true$$

$$owner ( 23 \to \{ 32 , 48 \} , {I}_{1}^{32} ) = true$$

$$participant ( 33 \to \{ 48 … 63 \} , {I}_{1}^{32} ) = true$$

There are three participants and thus the method shown in FIG. 5 cannot determine whether the mapping is BN compliant.

Step 130 may include determining of whether the ET is BN compliant is based, at least in part, on the multiple output bounding intervals and on the multiple input bounding intervals.

Step 130 may include determining that the ET is BN compliant based on relationships between input bounding intervals and output bounding intervals.

For example, step 130 may include determining whether the ET is BN compliant by steps 134, 135 and 136.

Step 134 may include defining input combinations that are pairs of BN input ports. Each pair of pair of BN input ports is associated, by the ET, with a pair of output subsets.

For example, assuming that the transformation is T={0→{0,3,8}, 1→{1,2,7}, 2→{5,10,18}, 3→{4,11,12,13}}.

The pairs of BN input ports are (0,1), (0,2), (0,3), (1,2), (1,3) and (2,3).

The associated pairs of output subsets include ({0,3,8}, {1,2,7}), ({0,3,8}, {5,10,18}), ({0,3,8}, {4,11,12,13}), ({1,2,7}, {5,10,18}), ({1,2,7}, {4,11,12,13}) and {{5,10,18}, {4,11,12,13}) respectively.

Step 134 may be followed by step 135 of determining pair bounding interval candidates.

A pair bounding interval candidate may be a minimal (smallest) interval that may start at a value that equals n*2k and has a length of 2k. Values k and n are non-negative integers. The pair bounding interval candidate bounds a numerical range defined by a first BN output port of a first output subset of the pair of output subsets and by a second BN output port of a second output subset of the pair of output-subsets.

For example, the pair of output subsets ({0,3,8}, {1,2,7}) includes a first output subset {0,3,8} and a second output subset {1,2,7}. Different pair bounding interval candidates bound different numerical ranges bounded by all possible pairs of elements that include one element of {0,3,8} and another value of {1,2,7})—for example cover different pairs of (0,1), (0,2), (0,7), (3,1), (3,2), (3,7), (8,1), (8,2) and (8,7).

Step 135 may be followed by step 136 of selecting a minimal (smallest) pair bounding interval candidate of the pair bounding interval candidates to be a pair bounding interval.

There may be a plurality of pairs of BN input ports- and a plurality of corresponding pairs of output subsets.

Step 136 may be followed by step 137 of determining that the ET is BN compliant is based on relationships between input bounding intervals and pair bounding intervals.

The relationships may be relationships between the sizes of the input bounding intervals and the size of the output bounding intervals.

For example, an ET is BN is for each one of the plurality of pairs of BN input ports, the size of the input bounding interval does not exceed a size of a pair bounding interval of an associated pairs of output subsets.

Assuming that the size of the bounding interval related to a numerical range (a,b) is denoted d(a,b), and that a selected pair bounding interval of pair of output subsets is denoted d({first output subset}, {second output subset}) then:

2=d(0,1)≤d({0,3,8},{1,2,7})=2

4=d(0,2)≤d({0,3,8},{5,10,18})=4

4=d(0,3)≤d({0,3,8},{4,11,12,13})=4

4=d(1,2)≤d({1,2,7},{5,10,18})=4

4=d(1,3)≤d({1,2,7},{4,11,12,13})=4

2=d(2,3)≤d({5,10,18},{4,11,12,13})=2

Note—d({0,3,8}, {1,2,7}) is the minimal value of d out of d(0,1), d(0,2), d(0,7), d(3,1), d(3,2), d(3,7), d(8,1), d(8,2) and d(8,7).

In this case the mentioned above condition is fulfilled- and the transformation is BT compliant.

Step 130 may be followed by step 150 of responding, by the transformation evaluation circuit, to the determining of step 130. Responding 150 may include outputting an indication of the result of the determination of whether the transformation is BN compliant.

For example, if the ET is BN compliant then the ET may be used during a hardware routing process in which hardware connectivity between BN users (for example, PEs) is determined.

It should be noted that when the ET is found to be non-BN compliant—then step 140 may include attempting to change the manner in which at least some of the PEs communicate—for example—use inter-HCs communication to convey from one PE to another PE a message and to provide the message to the BN from the other PE. This amendment may be referred to as software routing. The same correction may be applied, mutatis mutandis, to a message outputted from the BN—the massage may be outputted to one PE that will convey it to another PE via inter-HC communication.

The software routing may include splitting a numerical range—by assigning more BN ports to two or more subranges included in a previous single numerical range.

Step 150 may include finding that the ET is not BN compliant and amending the ET by defining a software routing operation that causes the ET to be BN compliant.

For example, assuming that the transformation is T=1→{0,8}, 3→{6}, 5→{16, 17, 18}, 17→{4,5}, 18→{1,15}, and 36→{13}.

Applying steps 134, 135, 136 and 137 results in finding that for some of the pairs of BN input ports, the size of the input bounding interval exceeds a size of pair bounding interval of an associated pair of output subsets. For example, d(1,18)=32—which exceeds d({0,8}, {1,15})=2. Yet for another example, d(1,36)=63 64—which exceeds d({0,8}, {13})=8.

Accordingly—the method shown in FIG. 5 cannot determine whether the mapping is BN compliant.

Step 150 may respond by rejecting the transformation. Step 150 may also include attempting to modify the transformation by applying software routing.

Assuming that the inter-HC connectivity (point to point connections connecting a PE to neighbors of the PE) of the following format:

TABLE A

| | | |
|---|---|---|
| HC(R, C − 1) | HC(R, C) | HC(R, C + 1) |
| (input port A − 1) | (input port A) | (input port A + 1) |
| HC(R + 1, C − 1) | HC(R + 1, C) | HC(R + 1, C + 1) |
| (input port A + 15) | (input port A + 16) | (input port A + 17) |
| HC(R + 2, C − 1) | HC(R + 2, C) | HC(R + 2, C + 1) |
| (input port A + 31) | (input port A + 32) | (input port A + 33) |

Assuming that input port X of the above transformation means that the HC at X position is emitting this data, we may use Table A (above) and Table B (below) to swap inlets between original emitters (HCs) and optional conveyers (neighboring HCs as depicted on table A):

TABLE B

| | | | | | |
|---|---|---|---|---|---|
| 0 | 1 | 2 | 3 | 4 | 5 |
| 16 | 17 | 18 | 19 | 20 | 21 |
| 32 | 33 | 34 | 35 | 36 | 37 |
| 48 | 49 | 50 | 51 | 52 | 53 |
| 64 | 65 | 66 | 67 | 68 | 69 |
| 80 | 81 | 82 | 83 | 84 | 85 |

Correction by transformation that swaps BN ports may include performing the following substitutes can be made 1→32, 3→36, 5→37, 17→34, 18→33, and 36→35.

This provides the following transportation: 32→[0,8], 33→[1,15], 34→[4,5], 35→[13], 36→[6], 37→[16,17,18],

Which is BN compliant, according to the inequalities presented before.

Alternatively, output subset splitting (which requires allocating more ports) may be used: 1→{0,8} is split to 0→{0} and 1→{8}. 18→(1, 15} is split to 18→{1}, and 19→{15}

This will provide the BN compliant transformation: T=0→{0}, 1→{8}, 3→{6}, 5→{16, 17, 18}, 17→{4,5}, 18→{1}, 19→{15}, 36→{13}.

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the disclosure may for the most part, be implemented using electronic components and circuits known to those skilled in the art, details will not be explained in any greater extent than that considered necessary as illustrated above, for the understanding and appreciation of the underlying concepts of the present embodiments of the disclosure and in order not to obfuscate or distract from the teachings of the present embodiments of the disclosure.

Any reference in the specification to a method should be applied mutatis mutandis to a system capable of executing the method and should be applied mutatis mutandis to a computer readable medium that is non-transitory and stores instructions for executing the method.

Any reference in the specification to a system should be applied mutatis mutandis to a method that may be executed by the system and should be applied mutatis mutandis to a computer readable medium that is non-transitory and stores instructions executable by the system.

Any reference in the specification to a computer readable medium that is non-transitory should be applied mutatis mutandis to a method that may be applied when executing instructions stored in the computer readable medium and should be applied mutatis mutandis to a system configured to execute the instructions stored in the computer readable medium.

The term “and/or” means additionally or alternatively.

A processing circuit may be implemented as a central processing unit (CPU), an application-specific integrated circuit (ASIC), a field programmable gate arrays (FPGA), a full-custom integrated circuit, a graphic processing unit (GPU), a hardware accelerator, a system on chip, and the like.

Any reference to any of the terms “comprise,” “comprises,” “comprising” “including,” “may include” and “includes” may be applied to any of the terms “consists,” “consisting,” “and consisting essentially of.” For example, any of method describing steps may include more steps than those illustrated in the figures, only the steps illustrated in the figures or substantially only the steps illustrate in the figures. The same applies to components of a device, processor, or system and to instructions stored in any non-transitory computer readable storage medium.

The subject matter may also be implemented in a computer program for running on a computer system, at least including code portions for performing steps of a method according to the subject matter when run on a programmable apparatus, such as a computer system or enabling a programmable apparatus to perform functions of a device or system according to the subject matter. The computer program may cause the storage system to allocate disk drives to disk drive groups.

A computer program is a list of instructions such as a particular application program or an operating system. The computer program may for instance include one or more of: a subroutine, a function, a procedure, an object method, an object implementation, an executable application, an applet, a servlet, a source code, an object code, a shared library/dynamic load library or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as flash memory, EEPROM, EPROM, ROM;

ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory, and a number of input/output (I/O) devices. When executing the computer program, the computer system processes information according to the computer program and produces resultant output information via I/O devices.

Example 1 is a method for finding a Benes network (BN) compliant transformation, the method comprises: receiving, by a transformation evaluation circuit, evaluated transformation (ET) information that represents an ET between multiple BN input ports to multiple output subsets of BN output ports, wherein the BN is a transformation supporting BN; determining an output bounding interval that bounds a numerical range defined by an output subset of the multiple output subsets; determining, by the transformation evaluation circuit, whether the ET is BN compliant based on, at least, the output bounding interval and the multiple output subsets; and outputting, by the transformation evaluation circuit, a determination result based on determining whether the ET is BN compliant.

In Example 2, the subject matter of Example 1 includes wherein the output bounding interval starts at n*2k and has a length of 2k, wherein k and n are non-negative integers.

In Example 3, the subject matter of Example 2 includes wherein the output bounding interval is a minimal bounding interval that bounds the numerical range.

In Example 4, the subject matter of Example 3 includes determining that the ET is BN compliant when there are between one and two output subsets of the multiple output subsets that are bound by the output bounding interval.

In Example 5, the subject matter of Examples 3-4 includes determining multiple output bounding intervals that bound numerical ranges defined by the multiple output subsets; wherein determining of whether the ET is BN compliant is based, at least in part, on the multiple output bounding intervals.

In Example 6, the subject matter of Example 5 includes determining input bounding intervals that bound numerical ranges defined by input combinations of BN input ports; wherein determining whether the ET is BN compliant is based, at least in part, on the multiple output bounding intervals and on multiple input bounding intervals.

In Example 7, the subject matter of Example 6 includes determining that the ET is BN compliant based on relationships between input bounding intervals and output bounding intervals.

In Example 8, the subject matter of Examples 6-7 includes wherein: the input combinations are pairs of BN input ports; and a pair of BN input ports is associated, by the ET, with a pair of output subsets.

In Example 9, the subject matter of Example 8 includes wherein: the pair of output subsets comprises a plurality of BN output ports; and the method further comprises calculating pair bounding interval candidates, each pair bounding interval candidate bounds a numerical range defined by a first BN output port of a first output subset of the pair of output subsets and by a second BN output port of a second output subset of the pair of output-subsets.

In Example 10, the subject matter of Example 9 includes selecting a minimal pair bounding interval candidate of the pair bounding interval candidates to be a pair bounding interval.

In Example 11, the subject matter of Example 10 includes wherein determining that the ET is BN compliant is based on relationships between input bounding intervals and pair bounding intervals.

In Example 12, the subject matter of Examples 10-11 includes finding that the ET is not BN compliant and amending the ET by defining a software routing operation that causes the ET to be BN compliant.

Example 13 is a non-transitory computer readable medium for finding a Benes network (BN) compliant transformation, the non-transitory computer readable medium storing instructions that once executed by a transformation evaluation circuit causes the transformation evaluation circuit to: receive evaluated transformation (ET) information that represents an ET between multiple BN input ports to multiple output subsets of BN output ports, wherein the BN is a transformation supporting BN; determine an output bounding interval that bounds a numerical range defined by an output subset of the multiple output subsets; determine whether the ET is BN compliant based on, at least, the output bounding interval and the multiple output subsets; and output a determination result based on determining whether the ET is BN compliant.

In Example 14, the subject matter of Example 13 includes wherein: the output bounding interval starts at n*2k and has a length of 2k; and k and n are non-negative integers.

In Example 15, the subject matter of Example 14 includes wherein the output bounding interval is a minimal bounding interval that bounds the numerical range.

In Example 16, the subject matter of Example 15 includes the instructions further causing the transformation evaluation circuit to determine that the ET is BN compliant when there are between one and two output subsets of the multiple output subsets that are bound by the output bounding interval.

In Example 17, the subject matter of Examples 15-16 includes the instructions further causing the transformation evaluation circuit to determine multiple output bounding intervals that bound numerical ranges defined by the multiple output subsets; wherein determining whether the ET is BN compliant is based, at least in part, on the multiple output bounding intervals.

In Example 18, the subject matter of Example 17 includes the instructions further causing the transformation evaluation circuit to determine input bounding intervals that bound numerical ranges defined by input combinations of BN input ports; wherein determining whether the ET is BN compliant is based, at least in part, on the multiple output bounding intervals and on multiple input bounding intervals.

In Example 19, the subject matter of Example 18 includes the instructions further causing the transformation evaluation circuit to determine that the ET is BN compliant based on relationships between input bounding intervals and output bounding intervals.

In Example 20, the subject matter of Examples 18-19 includes wherein: the input combinations are pairs of BN input ports; and a pair of BN input ports is associated, by the ET, with a pair of output subsets.

In Example 21, the subject matter of Example 20 includes wherein: the pair of output subsets comprises a plurality of BN output ports; and the instructions further causing the transformation evaluation circuit to calculate pair bounding interval candidates, each pair bounding interval candidate bounds a numerical range defined by a first BN output port of a first output subset of the pair of output subsets and by a second BN output port of a second output subset of the pair of output-subsets.

In Example 22, the subject matter of Example 21 includes the instructions further causing the transformation evaluation circuit to select a minimal pair bounding interval candidate of the pair bounding interval candidates to be a pair bounding interval.

In Example 23, the subject matter of Example 22 includes wherein determining that the ET is BN compliant is based on relationships between input bounding intervals and pair bounding intervals.

In Example 24, the subject matter of Examples 22-23 includes the instructions further causing the transformation evaluation circuit to find that the ET is not BN compliant and amending the ET by defining a software routing operation that causes the ET to be BN compliant.

Example 25 is at least one machine-readable medium including instructions that, when executed by processing circuitry, cause the processing circuitry to perform operations to implement of any of Examples 1-24.

Example 26 is an apparatus comprising means to implement of any of Examples 1-24.

Example 27 is a system to implement of any of Examples 1-24.

Example 28 is a method to implement of any of Examples 1-24.

In the foregoing specification, the subject matter has been described with reference to specific examples of embodiments of the subject matter. It will, however, be evident that various modifications and changes may be made therein without departing from the broader spirit and scope of the subject matter as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the subject matter described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative, and that alternative embodiments may merge logic blocks or circuit elements, or may impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

The illustrated examples may be implemented as circuitry located on a single integrated circuit or within a same device. Alternatively, the examples may be implemented as any number of separate integrated circuits or separate devices interconnected with each other in a suitable manner. The examples, or portions thereof, may implemented as soft or code representations of physical circuitry or of logical representations convertible into physical circuitry, such as in a hardware description language of any appropriate type.

The subject matter is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as “computer systems.”

Other modifications, variations and alternatives are also possible. The specifications and drawings are, accordingly, to be regarded in an illustrative rather than in a restrictive sense.

In the claims, any reference signs placed between parentheses shall not be construed as limiting the claim. The word “comprising” does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to the subject matter containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the subject matter have been illustrated and described herein, many modifications, substitutions, changes, and equivalents will now occur to those of ordinary skill in the art. It is, therefore, to be understood that the appended claims are intended to cover all such modifications and changes as fall within the true spirit of the subject matter.

1. A method for finding a Benes network (BN) compliant transformation, the method comprises:
receiving, by a transformation evaluation circuit, evaluated transformation (ET) information that represents an ET between multiple BN input ports to multiple output subsets of BN output ports, wherein the BN is a transformation supporting BN;
determining an output bounding interval that bounds a numerical range defined by an output subset of the multiple output subsets, wherein the output bounding interval represents a mathematical property of the transformation that is independent of physical network topology;
determining, by the transformation evaluation circuit, whether the ET is BN compliant based on, at least, the output bounding interval and the multiple output subsets; and
outputting, by the transformation evaluation circuit, a determination result based on determining whether the ET is BN compliant.

2. The method according to claim 1, wherein the output bounding interval starts at n*2k and has a length of 2k, wherein k and n are non-negative integers.

3. The method according to claim 2, wherein the output bounding interval is a minimal bounding interval that bounds the numerical range.

4. The method according to claim 3, further comprising determining that the ET is BN compliant when there are between one and two output subsets of the multiple output subsets that are bound by the output bounding interval.

5. The method according to claim 3, further comprising determining multiple output bounding intervals that bound numerical ranges defined by the multiple output subsets;
wherein determining of whether the ET is BN compliant is based, at least in part, on the multiple output bounding intervals.

6. The method according to claim 5, further comprising determining input bounding intervals that bound numerical ranges defined by input combinations of BN input ports;
wherein determining whether the ET is BN compliant is based, at least in part, on the multiple output bounding intervals and on multiple input bounding intervals.

7. The method according to claim 6, further comprising determining that the ET is BN compliant based on relationships between input bounding intervals and output bounding intervals.

8. The method according to claim 6, wherein:
the input combinations are pairs of BN input ports; and
a pair of BN input ports is associated, by the ET, with a pair of output subsets.

9. The method according to claim 8, wherein:
the pair of output subsets comprises a plurality of BN output ports; and
the method further comprises calculating pair bounding interval candidates, each pair bounding interval candidate bounds a numerical range defined by a first BN output port of a first output subset of the pair of output subsets and by a second BN output port of a second output subset of the pair of output-subsets.

10. The method according to claim 9, further comprising selecting a minimal pair bounding interval candidate of the pair bounding interval candidates to be a pair bounding interval.

11. The method according to claim 10, wherein determining that the ET is BN compliant is based on relationships between input bounding intervals and pair bounding intervals.

12. The method according to claim 10, further comprising finding that the ET is not BN compliant and amending the ET by defining a software routing operation that causes the ET to be BN compliant.

13. A non-transitory computer readable medium for finding a Benes network (BN) compliant transformation, the non-transitory computer readable medium storing instructions that once executed by a transformation evaluation circuit causes the transformation evaluation circuit to:
receive evaluated transformation (ET) information that represents an ET between multiple BN input ports to multiple output subsets of BN output ports, wherein the BN is a transformation supporting BN;
determine an output bounding interval that bounds a numerical range defined by an output subset of the multiple output subsets, wherein the output bounding interval represents a mathematical property of the transformation that is independent of physical network topology;
determine whether the ET is BN compliant based on, at least, the output bounding interval and the multiple output subsets; and
output a determination result based on determining whether the ET is BN compliant.

14. The non-transitory computer readable medium according to claim 13, wherein:
the output bounding interval starts at n*2k and has a length of 2k; and
k and n are non-negative integers.

15. The non-transitory computer readable medium according to claim 14,
wherein the output bounding interval is a minimal bounding interval that bounds the numerical range.

16. The non-transitory computer readable medium according to claim 15, the instructions further causing the transformation evaluation circuit to determine that the ET is BN compliant when there are between one and two output subsets of the multiple output subsets that are bound by the output bounding interval.

17. The non-transitory computer readable medium according to claim 15, the instructions further causing the transformation evaluation circuit to determine multiple output bounding intervals that bound numerical ranges defined by the multiple output subsets;
wherein determining whether the ET is BN compliant is based, at least in part, on the multiple output bounding intervals.

18. The non-transitory computer readable medium according to claim 17, the instructions further causing the transformation evaluation circuit to determine input bounding intervals that bound numerical ranges defined by input combinations of BN input ports;
wherein determining whether the ET is BN compliant is based, at least in part, on the multiple output bounding intervals and on multiple input bounding intervals.

19. The non-transitory computer readable medium according to claim 18, the instructions further causing the transformation evaluation circuit to determine that the ET is BN compliant based on relationships between input bounding intervals and output bounding intervals.

20. The non-transitory computer readable medium according to claim 18, (Original) wherein:
the input combinations are pairs of BN input ports; and
a pair of BN input ports is associated, by the ET, with a pair of output subsets.

21. The non-transitory computer readable medium according to claim 20, wherein:
the pair of output subsets comprises a plurality of BN output ports; and
the instructions further causing the transformation evaluation circuit to calculate pair bounding interval candidates, each pair bounding interval candidate bounds a numerical range defined by a first BN output port of a first output subset of the pair of output subsets and by a second BN output port of a second output subset of the pair of output-subsets.

22. The non-transitory computer readable medium according to claim 21, the instructions further causing the transformation evaluation circuit to select a minimal pair bounding interval candidate of the pair bounding interval candidates to be a pair bounding interval.

23. The non-transitory computer readable medium according to claim 22, wherein determining that the ET is BN compliant is based on relationships between input bounding intervals and pair bounding intervals.

24. The non-transitory computer readable medium according to claim 22, the instructions further causing the transformation evaluation circuit to find that the ET is not BN compliant and amending the ET by defining a software routing operation that causes the ET to be BN compliant.
